(19) United States
(12) Patent Application Publication
(10) Pub. No.: US 2013/0242055 A1
(43) Pub. Date: Sep. 19, 2013

(54) APPARATUS AND METHOD FOR EXTRACTING DEPTH IMAGE AND TEXTURE IMAGE

(71) Applicants: Hyon Gon Choo, Daejeon (KR); Jin Woong Kim, Daejeon (KR)

(72) Inventors: Hyon Gon Choo, Daejeon (KR); Jin Woong Kim, Daejeon (KR)

(73) Assignee: Electronics and Telecommunications Research Institute, Daejeon (KR)

(21) Appl. No.: 13/884,176

(22) PCT Filed: Nov. 3, 2011
(86) PCT No.: PCT/KR11/08271

§ 371 Date: May 8, 2013

(30) Foreign Application Priority Data
Nov. 8, 2010 (KR) 10-2010-0110377

(51) Int. Cl. H04N 13/02

(52) U.S. Cl. CPC H04N 13/0203
USPC 348/46

(57) ABSTRACT

Disclosed are a method and an apparatus for acquiring a texture image and a depth image in a scheme for acquiring a depth image based on a pattern image. An apparatus for acquiring a texture image and a depth image may include a pattern image irradiating unit to irradiate, onto a target object, a first pattern image and a second pattern image having a color complementary to a color of the first pattern image, an image taking unit to take a first screen image and a second screen image formed by irradiating the first pattern image and the second pattern image onto the target object, respectively, and an image processing unit to simultaneously extract a texture image and a depth image of the target object in the taken first screen image and the taken second screen image.

### CROSS REFERENCE

This application is a continuation of International Patent Application No. PCT/KR2011/008271, filed on Nov. 3, 2011, which claims priority to and the benefit of Korean Patent Application No. 10-2010-0110377, filed on Nov. 8, 2010, the disclosure of which is incorporated herein by reference in its entirety.

### TECHNICAL FIELD

The present invention relates to an apparatus and method for extracting a depth image and a texture image, and more particularly, to an apparatus and method for extracting a depth image and a texture image using two pattern images having colors complementary to each other.

### BACKGROUND ART

With developments in three-dimensional (3D) technology such as a 3D TV, a demand for extracting a depth image of a target object is increasing. As an existing scheme for extracting a depth image of a target object, a stereo matching scheme using two cameras, a depth image acquiring scheme based on a structured light, a depth image acquiring scheme that irradiates an infrared light and measures a returning time, and the like may be given.

The depth image acquiring scheme based on a structured light may correspond to a scheme of irradiating a pattern image encoded with predetermined information onto a target object, taking a scene image formed by irradiating the pattern image onto the target object, and analyzing an encoded pattern from the taken scene image to find a depth image of the target object from a changed amount of phase of the pattern.

As an example of the depth image acquiring scheme based on a structured light, a scheme of irradiating consecutive pattern images configured by R, G, and B onto a target object, and then taking scene images reflected from the target object using a high speed camera. To exert the same effect as irradiating a single white light, the scheme may consecutively irradiate pattern images configured by R, G, and B onto a single pixel, and may acquire a texture image and a depth image from three scene images formed by irradiating each pattern image onto the target object.

However, in a case of acquiring a texture image and a depth image at 30 frames per second, the scheme may use three scene images for each frame. Thus, a high speed projector, a high speed camera, a high speed synchronizing signal generating apparatus, and a memory apparatus having a three times or more fast speed may be desired, which may increase a system configuration cost.

Accordingly, a scheme for acquiring a texture image and a depth image with relatively less scene images using a general camera and projection is desired.

### DISCLOSURE OF INVENTION

### Technical Goals

An aspect of the present invention provides an apparatus and method for extracting a depth image and a texture image with relatively less scene images by using two pattern images having colors complementary to each other.

### Technical Solutions

According to an aspect of the present invention, there is provided an apparatus acquiring a texture image and a depth image including a pattern image irradiating unit to irradiate, onto a target object, a first pattern image and a second pattern image having a color complementary to a color of the first pattern image, an image taking unit to take a first screen image and a second screen image formed by irradiating the first pattern image and the second pattern image onto the target object, respectively, and an image processing unit to simultaneously extract a texture image and a depth image of the target object in the taken first screen image and the taken second screen image.

The first pattern image may include red (R), green (G), and blue (B), and the second pattern image may include cyan corresponding to R, magenta corresponding to G, and yellow corresponding to B.

According to an aspect of the present invention, there is provided a method acquiring a texture image and a depth image including irradiating, onto a target object, a first pattern image and a second pattern image having a color complementary to a color of the first pattern image, taking a first screen image and a second screen image formed by irradiating the first pattern image and the second pattern image onto the target object, respectively, and extracting a texture image and a depth image of the target object using the taken first screen image and the taken second screen image.

According to an embodiment, two pattern images having colors complementary to each other may be consecutively irradiated to acquire the same effect as a pattern image configured by consecutively irradiating R, G, and B and thus, a number of pattern images may be reduced.

According to an embodiment, by irradiating two pattern images having colors complementary to each other, scene images stored by a memory may be reduced and thus, an error due to a motion may be reduced.

### BRIEF DESCRIPTION OF DRAWINGS

FIG. 1 is a block diagram illustrating an apparatus for extracting a texture image and a depth image according to an embodiment of the present invention.

FIG. 2 is a diagram illustrating a complementary relationship between colors of light according to an embodiment of the present invention.

FIG. 3 is a diagram illustrating an example of a pattern image according to an embodiment of the present invention.

FIG. 4 is a flowchart illustrating a method of extracting a texture image and a depth image according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures. A method of extracting a texture image and a depth image according to an embodiment of the present invention may be implemented by an apparatus for extracting a texture image and a depth image.

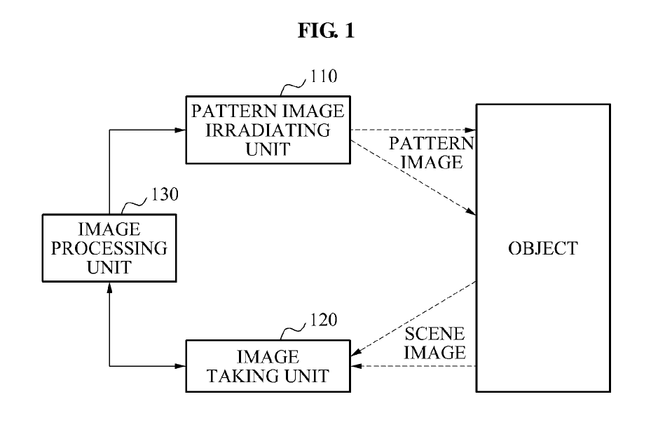

FIG. 1 is a block diagram illustrating an apparatus for extracting a texture image and a depth image according to an embodiment of the present invention.

Referring to FIG. 1, an apparatus for acquiring a texture image and a depth image according to an embodiment of the present invention may correspond to an apparatus based on a pattern image corresponding to a structured light, and may include a pattern image irradiating unit 110, an image taking unit 120, and an image processing unit 130.

The pattern image irradiating unit 110 may irradiate, onto a target object corresponding to a target to be taken, a first pattern image and a second pattern image having a color complementary to a color of the first pattern image. In particular, the pattern image irradiating unit 110 may include a frame buffer for storing a pattern image, and may sequentially irradiate, onto a target object, a pattern image stored in the frame buffer according to a synchronizing signal.

The image taking unit 120 may take a screen image the pattern image irradiating unit 110 forms by irradiating the pattern image onto the target object. In particular, the image taking unit 120 may take a first screen image and a second screen image formed by irradiating the first pattern image and the second pattern image onto the target object, respectively. In this instance, the image taking unit 120 may include at least one camera. As a number of cameras included in the image taking unit 120 increases, an accuracy of a depth image acquired by the image processing unit 130 may increase.

The image processing unit 130 may simultaneously extract a texture image and a depth image of the target object using the first screen image and the second screen image taken by the image taking unit 120.

The image processing unit 130 may combine the first screen image and the second screen image to extract the texture image with respect to the target object.

In particular, as shown in Equation 1, the image processing unit 130 may analyze a scene image I by a lighting A, information g₀ about a reflection with respect to the lighting A, and information S about a unique color of the target object.

I(λ)=g_{θ}S(λ)A(λ) [Equation 1]

The image processing unit 130 may analyze, as Equation 2, each of a first scene image I₁ formed by irradiating a first pattern image P₁ on the target object and a second scene image I₂ formed by irradiating a second pattern image P₂ on the target object.

$$\{ \begin{matrix}{I}_{1} ( λ ) = {g}_{θ} S ( λ ) [ A ( λ ) + {P}_{1} ( λ ) ] \\ {I}_{2} ( λ ) = {g}_{θ} S ( λ ) [ A ( λ ) + {P}_{2} ( λ ) ]\end{matrix} \qquad [ Equation 2 ]$$

In a case of configuring the lighting only with a pattern image without an existing lighting, the image processing unit 130 may analyze each of the first scene image I₁ and the second scene image I₂ as the following Equation 3.

$$\{ \begin{matrix}{I}_{1} ( λ ) = {g}_{θ} S ( λ ) [ {P}_{1} ( λ ) ] \\ {I}_{2} ( λ ) = {g}_{θ} S ( λ ) [ {P}_{2} ( λ ) ]\end{matrix} \qquad [ Equation 3 ]$$

In this instance, a lighting used in a broadcast may be a white light, and each pattern structure of the first pattern image P₁ and the second pattern image P₂ may form a complementary relationship and thus, the image processing unit 130 may calculate Equation 4 based on Equation 2 and Equation 3.

A(λ)=c(P₁(λ)+P₂(λ)) [Equation 4]

In a case where a lighting A has a light intensity less than a general lighting, that is, a white light, the image processing unit 130 may calculate a texture image Iₜ based on Equation 5. The image processing unit 130 may calculate the texture image Iₜ based on a sum of the first scene image and the second scene image. In this instance, c may correspond to a variable depending on a magnitude of a pattern image.

$$\begin{matrix}{I}_{t} ( λ ) = {g}_{θ} S ( λ ) A ( λ ) \\ = \frac{1}{1 + c} {g}_{θ} S ( λ ) A ( λ ) \\ = \frac{1}{1 + c} \{ {I}_{1} ( λ ) + {I}_{2} ( λ ) \}\end{matrix} \qquad [ Equation 5 ]$$

In this instance, the image processing unit 130 may calculate a texture image Iₜ by adjusting a value of c. For example, in a case where a value of c is assumed to be 1, the image processing unit 130 may calculate the texture image Iₜ based on Equation 6. The image processing unit 130 may calculate the texture image Iₜ using an arithmetic average of the first scene image I₁ and the second scene image I₂.

$${I}_{t} ( λ ) = \frac{{I}_{1} ( λ ) + {I}_{2} ( λ )}{2} \qquad [ Equation 6 ]$$

In a case of configuring a lighting only with a structured light as Equation 3, the image processing unit 130 may calculate the texture image Iₜ using only a sum of the first scene image I₁ and the second scene image I₂.

The image processing unit 130 may extract a depth image using a phase difference with respect to a color of each of the first scene image and the second scene image.

For example, the image processing unit 130 may extract a depth image with respect to a target object using a color of a texture image.

In particular, the image processing unit 130 may decode a color pattern using a color ratio (I₁/Iₜ) of the first scene image I₁ to the texture image Iₜ, and may extract a depth image based on the decoded color pattern.

The image processing unit 130 may decode a color pattern by weighting each channel according to Equation 7. For example, in a case where a color of a scene image in a single pixel corresponds to red, a value of a red channel may be basically and relatively large in the pixel and thus, the image processing unit 130 may give a relatively low weighing to the red channel of the pixel, and may give a relatively higher weighing than the weighing given to the red channel to the other channels in the pixel having relatively low values.

$$\frac{{I}_{1} ( λ )}{{I}_{t} ( λ )} = ( 1 + c ) \frac{{P}_{1} ( λ ) + A ( λ )}{A ( λ )} = ( 1 + c ) ( 1 + \frac{{P}_{1} ( λ )}{A ( λ )} ) \qquad [ Equation 7 ]$$

In this instance, when the image processing unit 130 compares values between each channel as Equation 8 based on Equation 7, an influence of a constant value may vanish. Thus, the image processing unit 130 may decode the color pattern using the largest value for each channel or a phase shift.

$$φ = {tan}^{- 1} ( \frac{R - G}{G - B} ) \qquad [ Equation 8 ]$$

The image processing unit 130 may numerically express the decoded color pattern, may acquire changed information of each expressed number, and may acquire a depth image using the changed information of each expressed number for a geometrical relation between a camera the pattern image irradiating unit 110.

An another example, similar to an existing scheme of extracting a change through a changing direction of a phase in an existing pattern, the image processing unit 130 may extract a depth image based on a changing direction of a channel between the first scene image and the second scene image.

In particular, the image processing unit 130 may decode a color pattern based on whether a change of a particular channel between the first scene image and the second scene image according to Equation 9 is opposite to a change of the other two channels, and may extract a depth image based on the decoded color pattern.

ΔI(λ)=I₂(λ)−I₁(λ)=g_{θ}S(λ)ΔP(λ) [Equation 9]

For example, as shown in Equation 10, the image processing unit 130 may decode using a different color pattern based on an increase and decrease in RGB. In particular, when a first pattern image irradiated to a single pixel corresponds to red, an RGB space of the pixel in the first scene image may correspond (255, 0, 0) and thus, red has the greatest value and the other two channels may have relatively smaller values. In this instance, when a pattern image irradiated to the pixel changes to a second pattern image corresponding to magenta over time, a RGB space of the pixel in the second scene image may correspond to (0, 255, 255) and thus, red may decrease and the other channel may increase. Since R changes to “−”, and G and B change to “+”, the image processing unit 130 may decode a color pattern of the pixel to code 0 based on the following Equation 10.

•R→MΔI(−, +, +):=>code 0

•G→CΔI(+, −, +):=>code 1

•B→YΔI(+, +, −):=>code 2 [Equation 10]

The image processing unit 130 may decode a color pattern of a current pattern image through which a channel has an amount in change inverse to another channel.

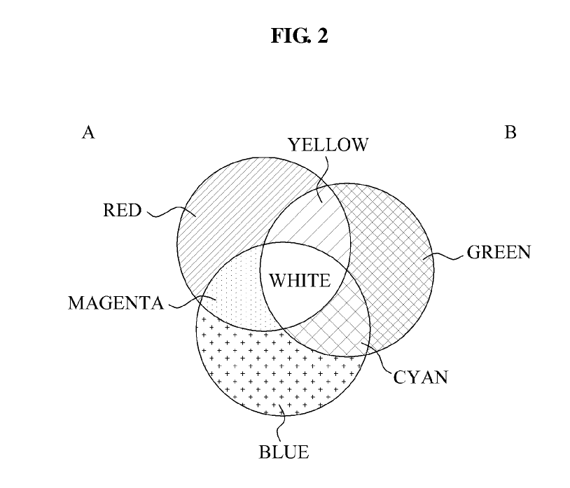

FIG. 2 is a diagram illustrating a complementary relationship between colors of light according to an embodiment of the present invention.

A light may indicate various colors according to a composition of red (R), green (G), and blue (B), and a white light may be generated when all of R, G, and B are composed. Thus, an existing apparatus for acquiring a texture image and a depth image has been using three types of pattern images each using one of the R, G, and B.

However, referring to FIG. 2, light may generate a white light in a case where colors complementary to each other are composed such as R and cyan, G and magenta, and B and yellow.

The pattern image irradiating unit 110 according to an embodiment of the present invention may obtain the same effect as irradiating three types of pattern images based on R, G, and B by alternately irradiating two pattern images having colors complementary to each other.

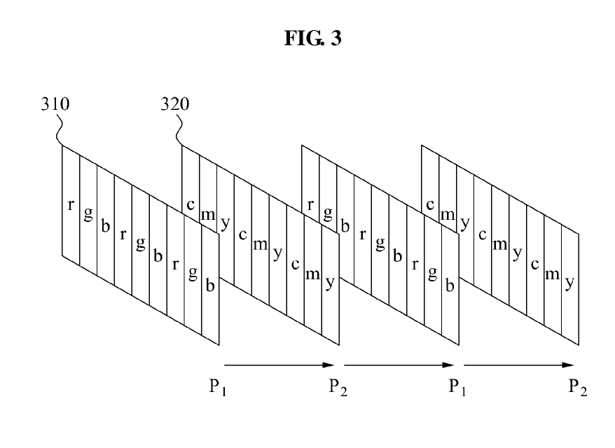

FIG. 3 is a diagram illustrating an example of a pattern image according to an embodiment of the present invention.

As illustrated in FIG. 3, the pattern image irradiating unit 110 according to an embodiment of the present invention may alternately irradiate a first pattern image 310 and a second pattern image 320. In this instance, the second pattern image 320 may use a color complementary to a color of the first pattern image 310.

As an example, in a case where a color of a pattern in the first pattern image 310 corresponds to R, a color of a pattern placed at the same location as the corresponding pattern in the second pattern image 320 may correspond to cyan. As another example, in a case where a color of a pattern in the first pattern image 310 corresponds to G, a color of a pattern placed at the same location as the corresponding pattern in the second pattern image 320 may correspond to magenta. The first pattern image 310 may be configured by R, G, and B, and the second pattern image 320 may be configured by cyan corresponding to R, magenta corresponding to G, and yellow corresponding to B.

Depending on embodiments, the first pattern image 310 may be configured by cyan, magenta, and yellow, and the second pattern image 320 may be configured by R corresponding to cyan, G corresponding to magenta, and B corresponding to yellow.

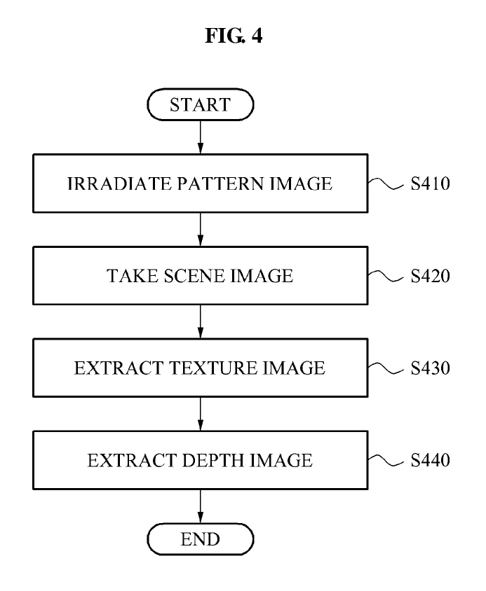

FIG. 4 is a flowchart illustrating a method of extracting a texture image and a depth image according to an embodiment of the present invention.

In operation S410, the pattern image irradiating unit 110 may sequentially and repeatedly irradiate, onto a target object, a first pattern image and a second pattern image having a color complementary to a color of the first pattern image.

In operation S420, the image taking unit 120 may take a first screen image and a second screen image formed by irradiating the first pattern image and the second pattern image onto the target object, respectively.

In operation S430, the image processing unit 130 may extract a texture image of the target object using the first screen image and the second screen image taken in operation S420.

In particular, the image processing unit 130 may extract a texture image based on Equation 5.

In operation S440, the image processing unit 130 may extract a depth image using the first screen image and the second screen image taken in operation S420.

In particular, the image processing unit 130 may extract a depth image with respect to the target object using a color of the texture image, and may extract a depth image based on a changing direction of a channel between the first screen image and the second screen image.

According to an embodiment, two pattern images having colors complementary to each other may be consecutively irradiated to acquire the same effect as a pattern image configured by consecutively irradiating R, G, and B and thus, a number of pattern images may be reduced. According to an embodiment, by irradiating two pattern images having colors complementary to each other, scene images stored by a memory may be reduced and thus, an error due to a motion may be reduced.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus comprising:
a pattern image irradiating unit to irradiate, onto a target object, a first pattern image and a second pattern image having a color complementary to a color of the first pattern image;
an image taking unit to take a first screen image and a second screen image formed by irradiating the first pattern image and the second pattern image onto the target object, respectively; and
an image processing unit to simultaneously extract a texture image and a depth image of the target object in the taken first screen image and the taken second screen image.

2. The apparatus of claim 1, wherein, to apply the same image effect as irradiating a white light onto the target object, the pattern image irradiating unit alternately irradiates the first pattern image and the second pattern image.

3. The apparatus of claim 1, wherein:
the first pattern image includes red (R), green (G), and blue (B), and the second pattern image includes cyan corresponding to R, magenta corresponding to G, and yellow corresponding to B.

4. The apparatus of claim 1, wherein the pattern image irradiating unit irradiates the first pattern image and the second pattern image based on a synchronizing signal of the image processing unit.

5. The apparatus of claim 1, wherein the image processing unit combines the first screen image and the second screen image to extract the texture image with respect to the target object.

6. The apparatus of claim 1, wherein the image processing unit extracts the depth image using a phase difference with respect to a color of each of the first screen image and the second screen image.

7. The apparatus of claim 6, wherein the image processing unit extracts the depth image with respect to the target object using a color of the texture image.

8. The apparatus of claim 7, wherein the image processing unit extracts the depth image using a color proportion of the first screen image to the texture image.

9. The apparatus of claim 6, wherein the image processing unit extracts the depth image based on a changing direction of a channel between the first screen image and the second screen image.

10. The apparatus of claim 9, wherein the image processing unit extracts the depth image based on whether a change of a predetermined channel between the first screen image and the second screen image is opposite to a change of the other two channels.

11. A method comprising:
irradiating, onto a target object, a first pattern image and a second pattern image having a color complementary to a color of the first pattern image;
taking a first screen image and a second screen image formed by irradiating the first pattern image and the second pattern image onto the target object, respectively; and
extracting a texture image and a depth image of the target object using the taken first screen image and the taken second screen image.

12. The method of claim 11, wherein, to exert the same image effect as irradiating a white light onto the target object, the irradiating comprises alternately irradiating the first pattern image and the second pattern image.

13. The method of claim 11, wherein:
the first pattern image includes red (R), green (G), and blue (B), and
the second pattern image includes cyan corresponding to R, magenta corresponding to G, and yellow corresponding to B.

14. The method of claim 11, wherein the irradiating comprises irradiating the first pattern image and the second pattern image based on a synchronizing signal.

15. The method of claim 11, wherein the extracting comprises combining the first screen image and the second screen image to extract the texture image with respect to the target object.

16. The method of claim 11, wherein the extracting comprises extracting the depth image using a phase difference with respect to a color of each of the first screen image and the second screen image.

17. The method of claim 16, wherein the extracting comprises extracting the depth image with respect to the target object using a color of the texture image.

18. The method of claim 17, wherein the extracting comprises extracting the depth image using a color proportion of the first screen image to the texture image.

19. The method of claim 16, wherein the extracting comprises extracting the depth image based on a changing direction of a channel between the first screen image and the second screen image.

20. The method of claim 19, wherein the extracting comprises extracting the depth image based on whether a change of a predetermined channel between the first screen image and the second screen image is opposite to a change of the other two channels.
